(19) United States
(12) Patent Application Publication
(10) Pub. No.: US 2020/0074934 A1
(43) Pub. Date: Mar. 5, 2020

(54) SOURCE DRIVER, DISPLAY DEVICE, AND SIGNAL TRANSMISSION METHOD

(71) Applicant: BOE TECHNOLOGY GROUP CO., LTD., Beijing (CN)

(72) Inventors: Fei YANG, Beijing (CN); Xiaolong WEI, Beijing (CN); Lirong WANG, Beijing (CN); Song MENG, Beijing (CN); Yi CHEN, Beijing (CN)

(21) Appl. No.: 16/387,954

(22) Filed: Apr. 18, 2019

(30) Foreign Application Priority Data
Aug. 30, 2018 (CN) 201811001253.5

(51) Int. Cl. G09G 3/3275

(52) U.S. Cl. CPC G09G 3/3275; G09G 2310/0243; G09G 2310/027; G09G 2310/08

(57) ABSTRACT

The present disclosure provides a source driver, a display device, and a signal transmission method, relating to the field of display technology. The source driver is configured to receive a first data signal from a timing controller, wherein the first data signal carries a control command; and transmit, under control of the control command, a reference clock signal and a sensing data signal to the timing controller simultaneously, wherein the sensing data signal is received by the timing controller under control of the reference clock signal.

### CROSS-REFERENCE TO RELATED APPLICATIONS

The present application claims priority to China Patent Application No. 201811001253.5, filed on Aug. 30, 2018, the disclosure of which is incorporated by reference herein in its entirety.

### TECHNICAL FIELD

The present disclosure relates to the field of display technology, and in particular, to a source driver, a display device, and a signal transmission method.

### BACKGROUND

With the development of display technology, Organic Light Emitting Diode (OLED) has been rapidly developed and has been applied to mobile terminals such as a mobile phone and other display devices.

### SUMMARY

According to one aspect of embodiments of the present disclosure, a source driver is provided. The source driver is configured to receive a first data signal from a timing controller, wherein the first data signal carries a control command; and transmit, under control of the control command, a reference clock signal and a sensing data signal to the timing controller simultaneously, wherein the sensing data signal is received by the timing controller under control of the reference clock signal.

In some embodiments, the source driver is further configured to generate the reference clock signal based on a clock frequency of the reference clock signal.

In some embodiments, the clock frequency of the reference clock signal is carried by the first data signal.

In some embodiments, the source driver is further configured to receive a base clock signal from the timing controller; and determine the clock frequency of the reference clock signal based on the base clock signal.

In some embodiments, the source driver comprises: a data parser configured to parse the control command from the first data signal; a clock signal generator configured to generate the reference clock signal according to a clock frequency of the reference clock signal, and transmit the reference clock signal to the timing controller under control of the control command; and an analog-to-digital converter configured to convert an analog voltage signal from a sensing line to the sensing data signal and transmit the sensing data signal to the timing controller under control of the control command.

In some embodiments, the data parser is further configured to parse at least one display data signal from the first data signal; the source driver further comprises: a digital-to-analog converter configured to convert, under control of a source control signal from the timing controller, each of the at least one display data signal into a corresponding data voltage signal, and transmit the corresponding data voltage signal to a corresponding data line.

In some embodiments, the control command carries a signal transmission trigger time; the clock signal generator is configured to start timing upon receiving the control command, and transmit the reference clock signal to the timing controller at a time the signal transmission trigger time is reached; the analog-to-digital converter is configured to start timing upon receiving the control command, and transmit the sensing data signal to the timing controller at the time the signal transmission trigger time is reached.

In some embodiments, the source driver is configured to differentially transmit the reference clock signal and the sensing data signal to the timing controller.

According to another aspect of embodiments of the present disclosure, a display device is provided. The display device comprises at least one source driver according to any one of the above embodiments; and a timing controller configured to transmit the first data signal to the at least one source driver; and receive the sensing data signal under control of the reference clock signal.

In some embodiments, the timing controller is further configured to generate a second data signal different from the first data signal according to externally input multicolor data and a timing control signal, and the sensing data signal, and transmit the second data signal to the at least one source driver.

In some embodiments, the timing controller is configured to receive the sensing data signal at a time corresponding to a rising edge or a falling edge of the reference clock signal.

In some embodiments, the timing controller is configured to differentially transmit the first data signal to the at least one source driver.

According to still another aspect of embodiments of the present disclosure, a signal transmission method is provided. The signal transmission method comprises: receiving, by a source driver, a first data signal from a timing controller, wherein the first data signal carries a control command; and transmitting a reference clock signal and a sensing data signal simultaneously to the timing controller under control of the control command, wherein the sensing data signal is received by the timing controller under control of the reference clock signal.

In some embodiments, the reference clock signal is generated by the source driver according to a clock frequency of the reference clock signal.

In some embodiments, the clock frequency of the reference clock signal is carried by the first data signal.

In some embodiments, the signal transmission method further comprises: receiving, by the source driver, a base clock signal from the timing controller; and determining, by the source driver, the clock frequency of the reference clock signal according to the base clock signal.

In some embodiments, the source driver comprises a data parser, a clock signal generator, and an analog-to-digital converter; transmitting the reference clock signal and the sensing data signal simultaneously to the timing controller under control of the control command comprises: parsing, by the data parser, the control command from the first data signal; generating, by the clock signal generator, the reference clock signal according to a clock frequency of the reference clock signal; transmitting, by the clock signal generator, the reference clock signal to the timing controller under control of the control command; converting, by the analog-to-digital converter, an analog voltage signal from a sensing line to the sensing data signal; and transmitting, by the analog-to-digital converter, the sensing data signal to the timing controller under control of the control command.

In some embodiments, the source driver further comprises a digital-to-analog converter; the signal transmission method further comprises: parsing, by the data parser, at least one display data signal from the first data signal; and converting, by the digital-to-analog converter, each of the at least one display data signal into a corresponding data voltage signal under control of a source control signal from the timing controller, and transmitting the corresponding data voltage signal to a corresponding data line.

In some embodiments, the control command carries a signal transmission trigger time; transmitting, by the clock signal generator, the reference clock signal to the timing controller under control of the control command comprises: starting, by the clock signal generator, timing upon receiving the control command, and transmitting the reference clock signal to the timing controller at a time the signal transmission trigger time is reached; transmitting, by the analog-to-digital converter, the sensing data signal to the timing controller under control of the control command comprises: starting, by the analog-to-digital converter, timing upon receiving the control command, and transmitting the sensing data signal to the timing controller at the time the signal transmission trigger time is reached.

In some embodiments, the reference clock signal and the sensing data signal are differentially transmitted to the timing controller by the source driver.

Other features, aspects and advantages of the present disclosure will become apparent from the following detailed description of exemplary embodiments of the present disclosure with reference to the accompanying drawings.

### BRIEF DESCRIPTION OF THE DRAWINGS

The accompanying drawings, which constitute part of this specification, illustrate exemplary embodiments of the present disclosure and, together with this specification, serve to explain the principles of the present disclosure.

The present disclosure can be understood more clearly from the following detailed description with reference to the accompanying drawings, in which:

FIG. 1 is a schematic structural view showing a source driver according to an embodiment of the present disclosure;

FIG. 2A is a schematic structural view showing a source driver according to an implementation of the present disclosure;

FIG. 2B is a schematic structural view showing a source driver according to another implementation of the present disclosure;

FIG. 3 is a schematic structural view showing a display device according to an embodiment of the present disclosure;

FIG. 4 is a schematic structural view showing a sub-pixel according to an embodiment of the present disclosure;

FIG. 5A is a schematic view showing a connection between a timing controller and source drivers according to an implementation of the present disclosure;

FIG. 5B is a schematic view showing a connection between a timing controller and source drivers according to another implementation of the present disclosure;

FIG. 6 is a schematic flow chart showing a signal transmission method according to an embodiment of the present disclosure.

It should be understood that the dimensions of the various parts shown in the accompanying drawings are not necessarily drawn according to the actual scale. In addition, the same or similar reference signs are used to denote the same or similar components.

### DETAILED DESCRIPTION

Various exemplary embodiments of the present disclosure will now be described in detail with reference to the accompanying drawings. The following description of the exemplary embodiments is merely illustrative and is in no way intended as a limitation to the present disclosure, its application or use. The present disclosure may be implemented in many different forms, which are not limited to the embodiments described herein. These embodiments are provided to make the present disclosure thorough and complete, and fully convey the scope of the present disclosure to those skilled in the art. It should be noticed that: relative arrangement of components and steps, material composition, numerical expressions, and numerical values set forth in these embodiments, unless specifically stated otherwise, should be explained as merely illustrative, and not as a limitation.

The use of the terms “first”, “second” and similar words in the present disclosure do not denote any order, quantity or importance, but are merely used to distinguish between different parts. A word such as “comprise”, “have” or variants thereof means that the element before the word covers the element(s) listed after the word without excluding the possibility of also covering other elements. The terms “up”, “down”, or the like are used only to represent a relative positional relationship, and the relative positional relationship may be changed correspondingly if the absolute position of the described object changes.

In the present disclosure, when it is described that a specific component is disposed between a first component and a second component, there may be an intervening component between the specific component and the first component or between the specific component and the second component. When it is described that a specific part is connected to other parts, the specific part may be directly connected to the other parts without an intervening part, or not directly connected to the other parts with an intervening part.

Unless otherwise defined, all terms (including technical and scientific terms) used herein have the same meanings as the meanings commonly understood by one of ordinary skill in the art to which the present disclosure belongs. It should also be understood that terms as defined in general dictionaries, unless explicitly defined herein, should be interpreted as having meanings that are consistent with their meanings in the context of the relevant art, and not to be interpreted in an idealized or extremely formalized sense.

Techniques, methods, and apparatus known to those of ordinary skill in the relevant art may not be discussed in detail, but where appropriate, these techniques, methods, and apparatuses should be considered as part of this specification.

In an OLED display device, when external compensation is performed on a pixel, a sensing data for compensation needs to be transmitted to a timing controller.

In the related art, the timing controller needs to transmit a clock signal to the source driver first when requiring a sensing data. The source driver transmits the sensing data to the timing controller upon receiving the clock signal, and the timing controller then receives the sensing data according to the clock signal. However, both the transmission of the clock signal and the transmission of the sensing data are time consuming, causing the sensing data received by the timing controller according to the clock signal inaccurate. The display performance of a display device, especially of a display device of a high frequency and high resolution, may be affected.

In order to solve the above problem, the present disclosure provides the following technical solutions.

FIG. 1 is a schematic structural view showing a source driver according to an embodiment of the present disclosure.

As shown in FIG. 1, the source driver 100 is configured to receive a first data signal DATA1 from a timing controller. Here, the first data signal DATA1 may be generated by the timing controller based on externally input multicolor data such as RGB (red, green, and blue) data and a timing control signal, and a sensing data signal received. The first data signal DATA1 carries a control command.

The first data signal DATA1 carries at least one display data signal. The source driver 100 is configured to convert each display data signal into a corresponding data voltage signal (i.e., a grayscale signal), and transmit each of the converted data voltage signals to a corresponding data line DL.

The source driver 100 is further configured to transmit, under control of the control command carried by the first data signal DATA1, a reference clock signal ACLK and a sensing data signal ADATA to the timing controller simultaneously. The timing controller receives the sensing data signal ADATA under control of the reference clock signal ACLK. For example, the timing controller may receive the sensing data signal ADATA at a time corresponding to a rising edge or a falling edge of the reference clock signal ACLK.

The sensing data signal ADATA is obtained through analog-to-digital conversion performed by the source driver 100 on an analog voltage signal from a sensing line SL. The sensing data signal ADATA may reflect optical characteristics (e.g., a turn-on voltage of an OLED) or electrical characteristics (e.g., a threshold voltage of a driving transistor) of a sub-pixel in a display panel.

In some implementations, the source driver 100 is further configured to generate a reference clock signal based on a clock frequency of the reference clock signal ACLK. For example, the first data signal DATA1 can carry the clock frequency of the reference clock signal ACLK. For another example, the source driver 100 is further configured to receive a base clock signal from the timing controller, and determine the clock frequency of the reference clock signal ACLK according to the base clock signal. In some embodiments, the clock frequency of the base clock signal is the clock frequency of the reference clock signal ACLK. In some implementations, the base clock signal may be a TTL (Transistor-Transistor-Logic) signal or a differential signal.

In the above embodiment, the first data signal received by the source driver carries a control command. The reference clock signal and the sensing data signal are transmitted simultaneously to the timing controller by the source driver under control of the control command. In this manner, the sensing data signal can be received in time by the timing controller under control of the reference clock signal. Thus the accuracy of the sensing data signal received by the timing controller is improved.

In some embodiments, the first data signal DATA1 can be differentially transmitted to the source driver 100 by the timing controller. In some embodiments, the reference clock signal ACLK and the sensing data signal ADATA can be differentially transmitted to the timing controller by the source driver 100. The signal transmission speed can be increased in a differential signal transmission way, and the accuracy of the sensing data signal received by the timing controller can be further improved.

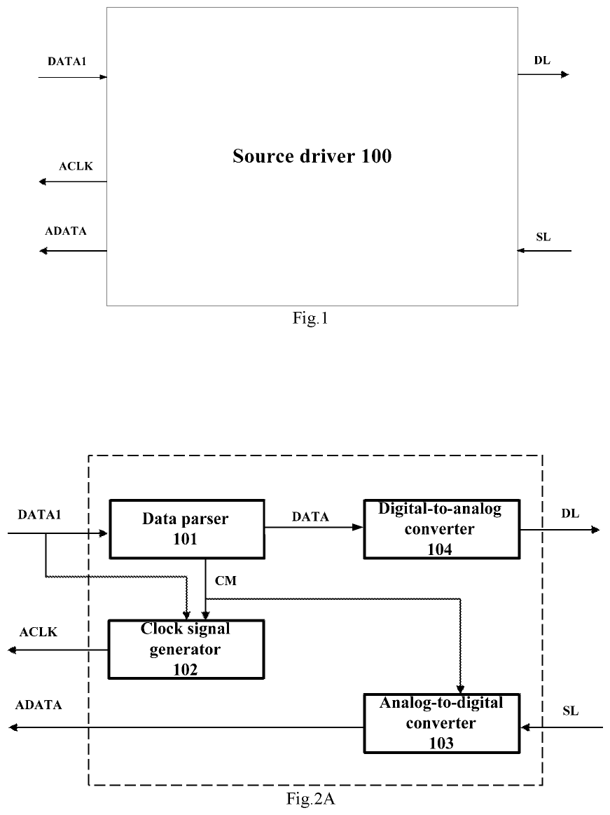

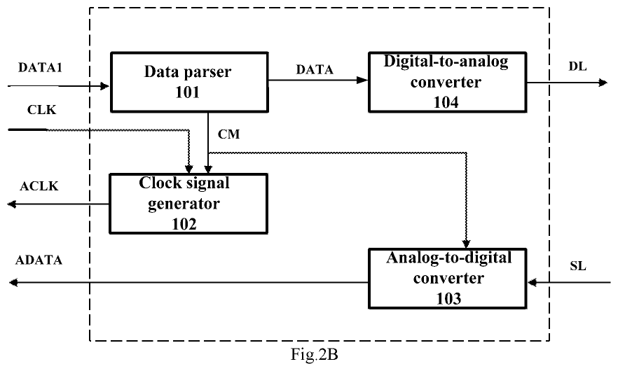

FIG. 2A is a schematic structural view showing a source driver according to an implementation of the present disclosure. FIG. 2B is a schematic structural view showing a source driver according to another implementation of the present disclosure.

As shown in FIGS. 2A and 2B, the source driver 100 comprises a data parser 101, a clock signal generator 102, and an analog-to-digital converter 103.

The data parser 101 is configured to parse a control command CM from the first data signal DATA1 and transmit the control command CM to the clock signal generator 102 and the analog-to-digital converter 103.

The clock signal generator 102 is configured to generate the reference clock signal ACLK according to the clock frequency of the reference clock signal ACLK, and transmit the reference clock signal ACLK to the timing controller under control of the control command CM.

In some implementations, as shown in FIG. 2A, the clock frequency of the reference clock signal ACLK may be carried by the first data signal DATA1. In other implementations, as shown in FIG. 2B, the source driver 100 is further configured to receive a base clock signal CLK from the timing controller. The clock frequency of the reference clock signal ACLK may be determined by the clock signal generator 102 according to the base clock signal CLK.

The analog-to-digital converter 103 is configured to convert an analog voltage signal from the sensing line SL into a sensing data signal ADATA (digital signal), and transmit the sensing data signal ADATA to the timing controller under control of the control command CM.

The time at which the reference clock signal ACLK is transmitted to the timing controller by the clock signal generator 102 is the same as the time at which the sensing data signal ADATA is transmitted to the timing controller by the analog-to-digital converter 103. For example, the control command CM carries a signal transmission trigger time. The clock signal generator 102 starts timing upon receiving the control command CM, and transmits the reference clock signal ACLK to the timing controller at a time the signal transmission trigger time is reached. Similarly, the analog-to-digital converter 103 starts timing upon receiving the control command CM, and transmits the sensing data signal ADATA to the timing controller at a time the signal transmission trigger time is reached.

In some embodiments, referring to FIGS. 2A and 2B, the source driver 100 further comprises a digital-to-analog converter 104. The data parser 101 is further configured to parse at least one display data signal DATA from the first data signal DATA1. The digital-to-analog converter 104 is configured to convert each display data signal DATA (digital signal) into a corresponding data voltage signal (analog signal) under control of the source control signal from the timing controller, and transmit each of the converted data voltage signals to a corresponding data line DL. For example, the at least one display data signal DATA comprises ten display data signals DATA. After each display data signal DATA has been converted into a corresponding data voltage signal, ten converted data voltage signals are respectively transmitted to corresponding data lines DL, for example, DL1, DL2 . . . DL10.

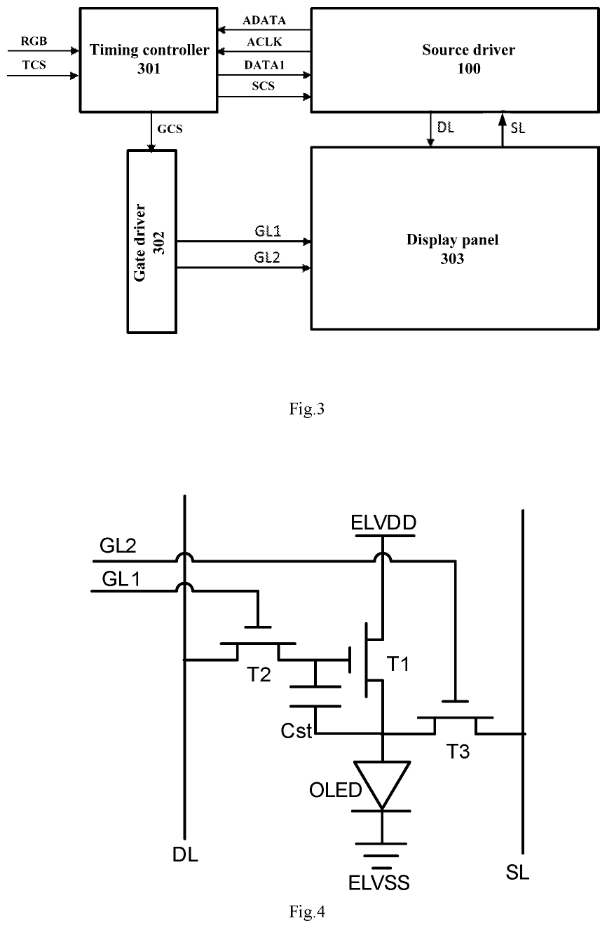

FIG. 3 is a schematic structural view showing a display device according to an embodiment of the present disclosure.

As shown in FIG. 3, the display device comprises at least one of the source driver 100 or the timing controller 301 of any one of the above embodiments. The timing controller 301 is configured to transmit the first data signal DATA1 to the source driver 100 and receive the sensing data signal ADATA under control of the reference clock signal ACLK. In some embodiments, the display device may be, for example, a mobile terminal, a television, a display, a notebook computer, a digital photo frame, a navigator, an electronic paper, or any product or component having a display function.

In the above embodiment, since the sensing data signal received by the timing controller is more accurate, the display effect of the display device can be improved.

Here, for the convenience of the subsequent description, FIG. 3 also shows a gate driver 302 and a display panel 303. The display panel 303 comprises a plurality of pixels, each of which comprises a plurality of sub-pixels, for example, 3 sub-pixels.

FIG. 4 is a schematic structural view showing a sub-pixel according to an embodiment of the present disclosure.

As shown in FIG. 4, the sub-pixel comprises a data line DL, a sensing line SL, two gate lines GL1 and GL2, an OLED device, a storage capacitor Cst, a switching transistor T2, a driving transistor T1, and a sensing transistor T3. The anode of the OLED device is connected to a voltage ELVDD via the driving transistor T1, and the cathode of the OLED device is connected to a voltage ELVSS. An optical characteristic value or an electrical characteristic value of the sub-pixel can be obtained by the sensing line SL.

The signal transmission method of the display device shown in FIG. 3 will be described below.

In the display stage, the first data signal DATA1, the source control signal SCS, and the gate control signal GCS are generated by the timing controller 301 with a compensation algorithm according to externally input multicolor data (for example, RGB data) and a timing control signal TCS, and a sensing data signal received (not shown in FIG. 3). A control command and at least one display data signal are carried by the first data signal DATA1. The first data signal DATA1 and the source control signal SCS are transmitted to the source driver 100, and the gate control signal GCS is transmitted to the gate driver 302 by the timing controller 301.

A control command and at least one display data signal is parsed from the first data signal DATA1 by the source driver 100. The reference clock signal ACLK can be generated by the source driver 100 according to a clock frequency carried by the first data signal DATA1.

Each display data signal is converted into a corresponding data voltage signal by the source driver 100 under control of the source control signal SCS and each data voltage signal is transmitted to the display panel 303 via a corresponding data line DL. A gate driving signal is generated by the gate driver 302 under control of the gate control signal GCS, and transmitted to the display panel 303 via a corresponding gate line (e.g., GL1 or GL2). A picture can be displayed on the display panel 303 with the cooperation of the gate driver 302 and the source driver 100. An optical or an electrical characteristic value (an analog voltage signal) of a corresponding sub-pixel can be sensed by a sensing line SL. The analog voltage signal from the sensing line SL can be converted into a digital voltage signal that is, sensing data signal ADATA, by the source driver 100.

The reference clock signal ACLK and the sensing data signal ADATA are transmitted simultaneously to the timing controller 301 by the source driver 100 under control of the control command. In some embodiments, a second data signal (not shown in FIG. 3) different from the first data signal DATA1 can be generated, according to the externally input multicolor data (e.g., RGB data) and the timing control signal TCS, and the sensing data signal ADATA, by the timing controller 301 with a compensation algorithm, and transmitted to the source driver 100. Similarly, a control command and at least one display data signal may be carried by the second data signal. A compensated picture can be displayed on the display panel 303 with the cooperation of the gate driver 302 and the source driver 100.

It should be understood that the display device comprising one source driver 100 is shown schematically in FIG. 3. In other implementations, the display device can comprise a plurality of source drivers 100. A schematic view showing a connection between a timing controller and a plurality of source drivers 100 will be described below with reference to FIGS. 5A and 5B.

FIG. 5A is a schematic view showing a connection between a timing controller and source drivers according to an implementation of the present disclosure. FIG. 5B is a schematic view showing a connection between a timing controller and source drivers according to another implementation of the present disclosure.

As shown in FIGS. 5A and 5B, the timing controller 301 can be connected to a plurality of source drivers 100, each of which can be connected to one or more data lines DL.

For convenience of illustration, it is assumed that there are totally N source drivers 100. Hereinafter, the N source drivers 100 arranged in order from left to right are sequentially referred to as first source driver 100, second source driver 100, . . . Nth source driver 100.

Next, the signal transmission between the timing controller 100 and each source driver 100 with the connection shown in FIG. 5A will be described.

First, a first data signal DATA1 carrying a control command and a clock frequency of reference clock signal ACLK is transmitted to the first source driver 100 by the timing controller 301. A reference clock signal ACLK is generated, by the first source driver 100, according to the clock frequency of the reference clock signal ACLK, and simultaneously transmitted to the timing controller 301 together with a sensing data signal ADATA under control of the control command.

Next, a first data signal DATA1 carrying a control command and a clock frequency of a reference clock signal ACLK is transmitted to the second source driver 100 by the timing controller 301. A sensing data signal ADATA and the reference clock signal ACLK are simultaneously transmitted, by the second source driver 100, to the timing controller 301 in a similar manner to the first source driver 100.

Similarly, finally, a first data signal DATA1 carrying a control command and a clock frequency of a reference clock signal ACLK is transmitted to the Nth source driver 100 by the timing controller 301. A sensing data signal ADATA and the reference clock signal ACLK are simultaneously transmitted, by the Nth source driver 100, to the timing controller 301 in a similar manner to the first source driver 100.

The signal transmission between the timing controller 100 and each source driver 100 with the connection shown in FIG. 5B is similar to the signal transmission between the timing controller 100 and each source driver 100 with the connection shown in FIG. 5A, except that: (1) the first data signal DATA1 carries a control command, and carries no clock frequency of a reference clock signal ACLK; and (2) a base clock signal CLK is further transmitted to each source driver 100 by the timing controller 301. A reference clock signal ACLK is generated by each source driver 100 according to a base clock signal CLK, and simultaneously transmitted to the timing controller 301 together with a sensing data signal ADATA under control of the control command.

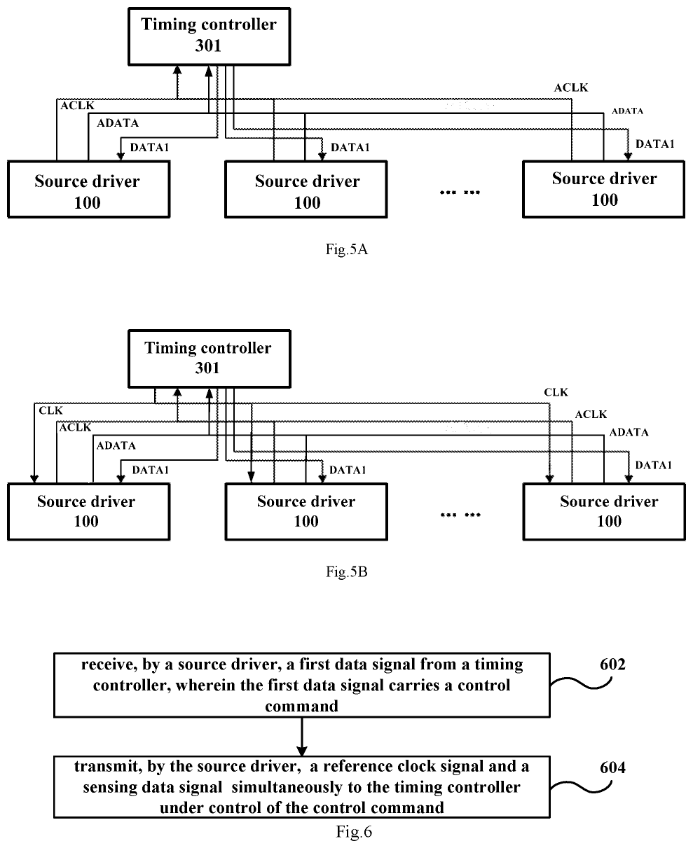

FIG. 6 is a schematic flow chart showing a signal transmission method according to an embodiment of the present disclosure.

At step 602, a first data signal from the timing controller is received by the source driver. The first data signal carries a control command.

Here, the first data signal may further carry at least one display data signal. Each display data signal is converted, by the source driver, into a corresponding data voltage signal, and the corresponding data voltage signal is transmitted to a corresponding data line.

At step 604, a reference clock signal and a sensing data signal are simultaneously transmitted to the timing controller by the source driver under control of the control command. The sensing data signal is received by the timing controller under control of the reference clock signal.

In some embodiments, the source driver may have a structure as shown in FIG. 2A or 2B. For the signal transmission in this case, reference can be made to the above description, which will not be describe in detail.

In the above embodiment, the first data signal received by the source driver carries a control command. The reference clock signal and the sensing data signal are simultaneously transmitted to the timing controller by the source driver under control of the control command. In this manner, the sensing data signal can be received in time by the timing controller under control of the reference clock signal. Thus the accuracy of the sensing data signal received by the timing controller is improved.

In some embodiments, the reference clock signal is generated by the source driver according to a clock frequency of the reference clock signal. The clock frequency of the reference clock signal can be obtained in different ways. In some implementations, the clock frequency of the reference clock signal can be carried by the first data signal. In other implementations, the clock frequency of the reference clock signal can be determined by the source driver according to a base clock signal from the timing controller.

Hereto, various embodiments of the present disclosure have been described in detail. Some details well known in the art are not described to avoid obscuring the concept of the present disclosure. According to the above description, those skilled in the art would fully know how to implement the technical solutions disclosed herein.

Although some specific embodiments of the present disclosure have been described in detail by way of examples, those skilled in the art should understand that the above examples are only for the purpose of illustration and are not intended to limit the scope of the present disclosure. It should be understood by those skilled in the art that modifications to the above embodiments and equivalently substitution of part of the technical features can be made without departing from the scope and spirit of the present disclosure. The scope of the disclosure is defined by the following claims.

What is claimed is:

1. A source driver configured to:
receive a first data signal from a timing controller, wherein the first data signal carries a control command; and
transmit, under control of the control command, a reference clock signal and a sensing data signal to the timing controller simultaneously, wherein the sensing data signal is received by the timing controller under control of the reference clock signal.

2. The source driver according to claim 1, wherein the source driver is further configured to generate the reference clock signal based on a clock frequency of the reference clock signal.

3. The source driver according to claim 2, wherein the clock frequency of the reference clock signal is carried by the first data signal.

4. The source driver according to claim 2, wherein the source driver is further configured to:
receive a base clock signal from the timing controller; and
determine the clock frequency of the reference clock signal based on the base clock signal.

5. The source driver according to claim 1, comprising:
a data parser configured to parse the control command from the first data signal;
a clock signal generator configured to generate the reference clock signal according to a clock frequency of the reference clock signal, and transmit the reference clock signal to the timing controller under control of the control command; and
an analog-to-digital converter configured to convert an analog voltage signal from a sensing line to the sensing data signal and transmit the sensing data signal to the timing controller under control of the control command.

6. The source driver according to claim 5, wherein the data parser is further configured to parse at least one display data signal from the first data signal;
the source driver further comprises:
a digital-to-analog converter configured to convert, under control of a source control signal from the timing controller, each of the at least one display data signal into a corresponding data voltage signal, and transmit the corresponding data voltage signal to a corresponding data line.

7. The source driver according to claim 5, wherein the control command carries a signal transmission trigger time;
the clock signal generator is configured to start timing upon receiving the control command, and transmit the reference clock signal to the timing controller at a time the signal transmission trigger time is reached;
the analog-to-digital converter is configured to start timing upon receiving the control command, and transmit the sensing data signal to the timing controller at the time the signal transmission trigger time is reached.

8. The source driver according to claim 1, wherein the source driver is configured to differentially transmit the reference clock signal and the sensing data signal to the timing controller.

9. A display device, comprising at least one source driver and a timing controller, wherein:
the at least one source driver is configured to receive a first data signal from the timing controller, wherein the first data signal carries a control command, and transmit, under control of the control command, a reference clock signal and a sensing data signal to the timing controller simultaneously, wherein the sensing data signal is received by the timing controller under control of the reference clock signal; and
the timing controller is configured to transmit the first data signal to the at least one source driver, and receive the sensing data signal under control of the reference clock signal.

10. The display device according to claim 9, wherein the timing controller is further configured to generate a second data signal different from the first data signal according to externally input multicolor data and a timing control signal, and the sensing data signal, and transmit the second data signal to the at least one source driver.

11. The display device according to claim 9, wherein the timing controller is configured to receive the sensing data signal at a time corresponding to a rising edge or a falling edge of the reference clock signal.

12. The display device according to claim 9, wherein the timing controller is configured to differentially transmit the first data signal to the at least one source driver.

13. A signal transmission method, comprising:
receiving, by a source driver, a first data signal from a timing controller, wherein the first data signal carries a control command; and
transmitting a reference clock signal and a sensing data signal simultaneously to the timing controller under control of the control command, wherein the sensing data signal is received by the timing controller under control of the reference clock signal.

14. The signal transmission method according to claim 13, wherein the reference clock signal is generated by the source driver according to a clock frequency of the reference clock signal.

15. The signal transmission method according to claim 14, wherein the clock frequency of the reference clock signal is carried by the first data signal.

16. The signal transmission method according to claim 14, further comprising:
receiving, by the source driver, a base clock signal from the timing controller; and
determining, by the source driver, the clock frequency of the reference clock signal according to the base clock signal.

17. The signal transmission method according to claim 13, wherein the source driver comprises a data parser, a clock signal generator, and an analog-to-digital converter;
transmitting the reference clock signal and the sensing data signal simultaneously to the timing controller under control of the control command comprises:
parsing, by the data parser, the control command from the first data signal;
generating, by the clock signal generator, the reference clock signal according to a clock frequency of the reference clock signal;
transmitting, by the clock signal generator, the reference clock signal to the timing controller under control of the control command;
converting, by the analog-to-digital converter, an analog voltage signal from a sensing line to the sensing data signal; and
transmitting, by the analog-to-digital converter, the sensing data signal to the timing controller under control of the control command.

18. The signal transmission method according to claim 17, wherein the source driver further comprises a digital-to-analog converter;
the signal transmission method further comprises:
parsing, by the data parser, at least one display data signal from the first data signal; and
converting, by the digital-to-analog converter, each of the at least one display data signal into a corresponding data voltage signal under control of a source control signal from the timing controller, and transmitting the corresponding data voltage signal to a corresponding data line.

19. The signal transmission method according to claim 17, wherein the control command carries a signal transmission trigger time;
transmitting, by the clock signal generator, the reference clock signal to the timing controller under control of the control command comprises:
starting, by the clock signal generator, timing upon receiving the control command, and transmitting the reference clock signal to the timing controller at a time the signal transmission trigger time is reached;
transmitting, by the analog-to-digital converter, the sensing data signal to the timing controller under control of the control command comprises:
starting, by the analog-to-digital converter, timing upon receiving the control command, and transmitting the sensing data signal to the timing controller at the time the signal transmission trigger time is reached.

20. The signal transmission method according to claim 13, wherein the reference clock signal and the sensing data signal are differentially transmitted to the timing controller by the source driver.
